(19) United States
(12) Patent Application Publication
(10) Pub. No.: US 2008/0184368 A1
(43) Pub. Date: Jul. 31, 2008

(54) Preventing False Positive Detections in an Intrusion Detection System

(76) Inventors: James R. Coon, Rochester, MN (US); Daniel P. Kolz, Rochester, MN (US); Jeffrey M. Uehling, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/669,575

(22) Filed: Jan. 31, 2007

(51) Int. Cl. G06F 21/00; G06F 11/30

(52) U.S. Cl. 726/23

(57) ABSTRACT

Methods, systems, and products are disclosed for preventing false positive detections in an intrusion detection system that include: establishing one or more activity profiles for an intrusion detection system, each activity profile specifying system activity for detection by the intrusion detection system; receiving, in the intrusion detection system, an exception notification for a specific activity profile, the exception notification specifying that the specific activity profile represents authorized system activity; determining, by the intrusion detection system, whether current system activity matches the specific activity profile; and administering, by the intrusion detection system, the current system activity if current system activity matches the specific activity profile.

### BACKGROUND OF THE INVENTION

1. Field of the Invention

The field of the invention is data processing, or, more specifically, methods, systems, and products for preventing false positive detections in an intrusion detection system.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computer systems have evolved and impacted every aspect of society, system designers have developed powerful tools to protect computer systems from intrusion and abuse. Such tools include an Intrusion Detection System (‘IDS’) and an Intrusion Prevention System (‘IPS’). An IDS generally detects unwanted manipulations of computer systems including various types of malicious network traffic and computer usage that cannot be detected by a conventional firewall. Such unwanted manipulations may include network attacks against vulnerable services, data driven attacks on applications, host based attacks such as privilege escalation, unauthorized logins, and access to sensitive files, and malicious software such as viruses, trojan horses, and worms.

An IDS generally detects unwanted manipulations of computer systems by comparing system activity with various activity profiles for prohibited or abnormal behavior. For example, an IDS may indicate that an attack on a computer system is in progress when the IDS detects a user checking every port on a server to identify whether a service is available on one of the server ports. Checking every port on a server to identify whether a service is available is a classic technique that attackers use when breaking into a network. An additional example may include an IDS indicating an attack upon detecting the transmission of network packets from a workstation at 3 a.m. when workstations on the network typically do not generate such network traffic at night. Such network activity may indicate that a user is attempting to hide a particular behavior.

An IPS is typically designed around the detection capabilities of an IDS. An IPS operates to prevent attackers from gaining access or utilizing system resources. An IPS relies on the IDS to detect suspicious system activity and then takes action to stop the suspicious system activity. For example, if an IDS detects a user from outside a network scanning the ports of computers inside the network, then an IPS may configure a firewall rule to disallow access to the network from the user's IP address. Because of the interrelated functionally provided by an IDS and an IPS, the activity detection functionality provided by an IDS may be incorporated into an IPS, and the activity prevention functionality provided by an IPS may be incorporated into an IDS.

A drawback to current intrusion detection systems is that many administration security tools perform system activities that resemble attacks. For example, system administrators may often use such administration security tools to identify whether any open ports are available on a computer when configuring software or detecting attack vulnerabilities. Such standard administration activities may result in a false positive detection error by an IDS. That is, the IDS may detect system activity that indicates unauthorized behavior is occurring when, in fact, no unauthorized behavior is occurring at all. As such, readers will therefore appreciate that room for improvement exists for preventing false positive detections in an intrusion detection system.

### SUMMARY OF THE INVENTION

Methods, systems, and products are disclosed for preventing false positive detections in an intrusion detection system that include: establishing one or more activity profiles for an intrusion detection system, each activity profile specifying system activity for detection by the intrusion detection system; receiving, in the intrusion detection system, an exception notification for a specific activity profile, the exception notification specifying that the specific activity profile represents authorized system activity; determining, by the intrusion detection system, whether current system activity matches the specific activity profile; and administering, by the intrusion detection system, the current system activity if current system activity matches the specific activity profile.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network and block diagram of a system for preventing false positive detections in an intrusion detection system according to embodiments of the present invention.

FIG. 2 sets forth a block diagram of automated computing machinery comprising an exemplary computer useful in preventing false positive detections in an intrusion detection system according to embodiments of the present invention.

FIG. 3 sets forth a flow chart illustrating an exemplary method for preventing false positive detections in an intrusion detection system according to embodiments of the present invention.

FIG. 4 sets forth a flow chart illustrating a further exemplary method for preventing false positive detections in an intrusion detection system according to embodiments of the present invention.

FIG. 5 sets forth a flow chart illustrating a further exemplary method for preventing false positive detections in an intrusion detection system according to embodiments of the present invention.

FIG. 6 sets forth a flow chart illustrating an exemplary method for establishing one or more activity profiles for an intrusion detection system according to embodiments of the present invention.

### DETAILED DESCRIPTION OF EXEMPLARY EMBODIMENTS

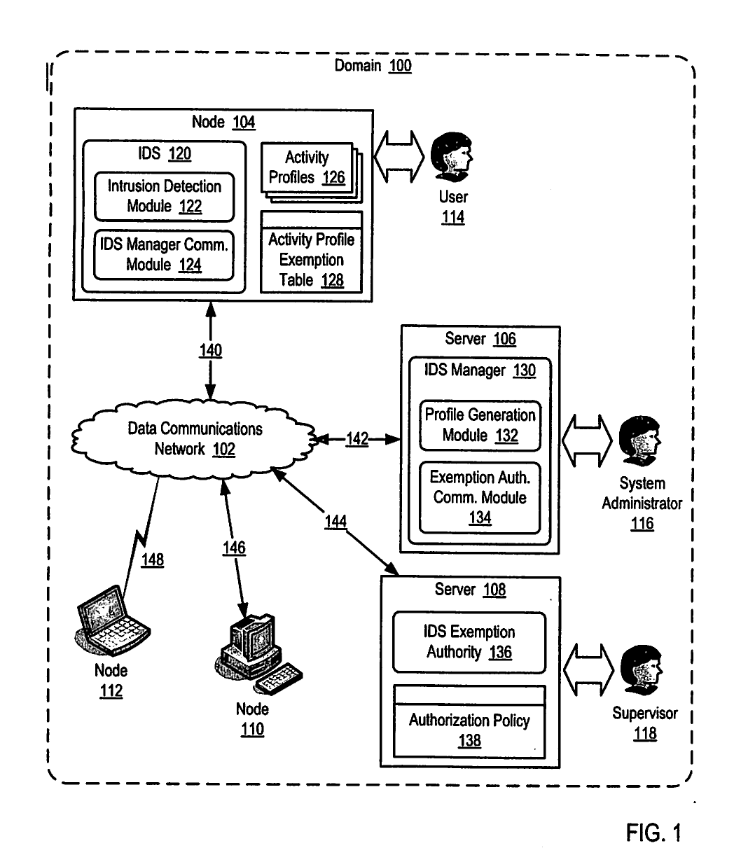

Exemplary methods, systems, and products for preventing false positive detections in an intrusion detection system in accordance with the present invention are described with reference to the accompanying drawings, beginning with FIG. 1. FIG. 1 sets forth a network and block diagram of a system for preventing false positive detections in an intrusion detection system according to embodiments of the present invention.

A false positive detection is a type of statistical detection error that occurs in a system when the system accepts a false alternative hypothesis instead of accepting a null hypothesis that is actually true. A null hypothesis represents a presumed default ‘state of nature,’ for example, that a potential login candidate is not authorized. An alternative hypothesis corresponds to the null hypothesis and represents the opposite situation, for example, that the login candidate is an authorized user. In an intrusion detection system, the null hypothesis represents that detected system activity is authorized, and the alternative hypothesis represents that detected system activity is unauthorized. A false positive detection in such an IDS context means that an intrusion detection system detects system activity and administers the system activity as though it was unauthorized when the detected system activity is, in fact, authorized system activity.

The system of FIG. 1 operates for preventing false positive detections in an intrusion detection system in accordance with the present invention as follows: One or more activity profiles (126) are established for an intrusion detection system (120). Each activity profile (126) specifies system activity for detection by the intrusion detection system (120). The intrusion detection system (120) receives an exception notification for a specific activity profile. The exception notification specifies that the specific activity profile represents authorized system activity. The intrusion detection system (120) determines whether current system activity matches the specific activity profile. The intrusion detection system (120) administers the current system activity if current system activity matches the specific activity profile.

The system of FIG. 1 also operates for preventing false positive detections in an intrusion detection system in accordance with the present invention as follows: An intrusion detection system manager (130) receives an exemption request for the specific activity profile. The exemption request specifies a request for authorization to perform system activity specified in the specific activity profile. An intrusion detection system exemption authority (136) authorizes performance of the system activity specified in the specific activity profile. The intrusion detection system manager (130) the exception notification (304) for the specific activity profile to the intrusion detection system (120).

The exemplary system of FIG. 1 includes nodes (104, 112, 110) and servers (106, 108) connected to data communications network (102). The data communications network (102) provides the infrastructure for connecting together the devices (104, 106, 108, 110, 112) for data communications within domain (100) and to other networks (not shown) using routers, gateways, switching devices, and other network components as will occur to those of skill in the art. In the exemplary system of FIG. 1, the node (104) connects to network (102) through wireline connection (140). The node (110) connects to network (102) through wireline connection (146). The node (112) connects to network (102) through wireless connection (148). The server (106) connects to network (102) through wireline connection (142). The server (108) connects to network (102) through wireline connection (144). The term ‘domain’ in this specification means a particular networked environment. In the example of FIG. 1, the domain (100) includes network (102) and the devices (104, 106, 108, 110, 112) connected to network (102).

In the exemplary system of FIG. 1, the node (104) is a computer device having installed upon it an intrusion detection system (120). The intrusion detection system (120) of FIG. 1 is a software component that detects system activity occurring on the node (104) and within the network (102). The system activity detected by the IDS (120) may include local system activity that results from manipulations of the node (104) by user (114) or computer software installed on the node (104). The system activity detected by the IDS (120) may also include network activity generated or received by the other nodes (110, 112) and servers (142, 144) connected to the network (102).

The intrusion detection system (120) of FIG. 1 includes an intrusion detection module (122). The intrusion detection module (122) of FIG. 1 includes computer program instructions for detecting system activity specified in activity profiles (126). Each activity profile (126) of FIG. 1 is a data structure specifying a set of conditions that define a particular system activity for detection by an IDS. For example, an activity profile may specify conditions that are used to define when a user copies a particular file, when a node receives a particular pattern of data requests through a network, when a software component modifies system files, and so on. An IDS detects a particular system activity when all the conditions specified in an activity profile are satisfied.

The intrusion detection module (122) of FIG. 1 also includes computer program instructions for preventing false positive detections in an intrusion detection system according to embodiments of the present invention. The intrusion detection module (122) operates generally for preventing false positive detections in an intrusion detection system according to embodiments of the present invention by establishing one or more activity profiles (126) for an intrusion detection system, each activity profile (126) specifying system activity for detection by the intrusion detection system, receiving an exception notification for a specific activity profile (126), the exception notification specifying that the specific activity profile represents authorized system activity, determining whether current system activity matches the specific activity profile, and administering the current system activity if current system activity matches the specific activity profile.

In the exemplary system of FIG. 1, the IDS (120) maintains an activity profile exemption table (128). The activity profile exemption table (128) is a list of activity profiles that specify authorized system activity. The IDS (120) utilizes the activity profile exemption table (128) when determining whether current system activity matches a specific activity profile that represents authorized system activity. The activity profile exemption table (128) is so termed because the system activity specified in an activity profile listed in the table (128) is exempt from normal processing by the IDS (120) that attempts to prevent or halt the system activity from occurring. Although the exemplary system of FIG. 1 includes the activity profile exemption table (128), readers will note that such a table is for explanation and not for limitation. Other ways of specifying authorized system activity as will occur to those of skill in the art may also be useful in preventing false positive detections in an intrusion detection system according to embodiments of the present invention such as, for example, using an authorized activity field in each activity profile.

In the exemplary system of FIG. 1, the intrusion detection system (120) also includes an IDS manager communications module (124) for communicating with an IDS manager (130). The IDS manager communications module (124) of FIG. 1 may implement data communications between the IDS (120) and the IDS manager (130) using a CORBA framework, the Java Remote Method Invocation (‘RMI’) API, web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

In the exemplary system of FIG. 1, the server (106) is a computer device having installed upon it an IDS manager (120). The IDS manager (120) of FIG. 1 is a software component that manages one or more intrusion detection systems. The IDS manager (120) of FIG. 1 includes a set of computer program instructions to manage each intrusion detection system installed in the domain (100). The IDS manager (120) monitors events and alerts from each IDS and reports the activity to a system administrator (116). The IDS manager (120) controls each IDS by administering the sensing and detecting functionality provided by each IDS. The IDS manager (120) of FIG. 1 includes a set of computer program instructions for preventing false positive detections in an intrusion detection system according to embodiments of the present invention. The IDS manager (120) of FIG. 1 operates generally for preventing false positive detections in an intrusion detection system according to embodiments of the present invention by receiving an exemption request for the specific activity profile, the exemption request specifying a request for authorization to perform system activity specified in the specific activity profile, and providing, to the intrusion detection system (120), the exception notification (304) for the specific activity profile. In the exemplary system of FIG. 1, the IDS manager (130) receives the exemption request from system administrator (116).

To create the activity profiles that specify particular system activity, the IDS manager (130) of FIG. 1 includes a profile generation module (132). The profile generation module (132) of FIG. 1 is a software module that generates activity profiles used by an IDS to detect system activity. The profile generation module (132) of FIG. 1 includes a set of computer program instructions for preventing false positive detections in an intrusion detection system according to embodiments of the present invention. The profile generation module (132) of FIG. 1 operates generally for preventing false positive detections in an intrusion detection system according to embodiments of the present invention by capturing system activity for detection by the intrusion detection system, creating an activity profile in dependence upon the captured system activity, and providing the created activity profile to one or more intrusion detection systems.

Before the IDS manager (130) provides an exemption notification for a specific activity profile specified in an exemption request, the IDS manager (130) obtains authorization to issue an exemption notification to IDS (120) from an IDS exemption authority. The IDS manager (130) communicates with an IDS exemption authority using an exemption authority communications module (134). The exemption authority communications module (134) of FIG. 1 may implement data communications between the IDS manager (130) and the IDS exemption authority (136) using a CORBA framework, the Java Remote Method Invocation (‘RMI’) API, web services, or any other communication implementation as will occur to those of skill in the art.

In the exemplary system of FIG. 1, the server (108) is a computer device having installed upon it an IDS exemption authority (136). The IDS exemption authority (136) is a software component that includes a set of computer program instructions for preventing false positive detections in an intrusion detection system according to embodiments of the present invention. The IDS exemption authority (136) operates generally for preventing false positive detections in an intrusion detection system according to embodiments of the present invention by authorizing the performance of the system activity specified in a specific activity profile. The IDS exemption authority (136) may authorize the performance of the system activity specified in a specific activity profile based on an authorization policy (138) or user indications received from a supervisor (118). In the example of FIG. 1, the intrusion detection system exemption authority (136) provides authorization services for exemption requests received in the domain (100). Providing exemption request authorization through an IDS exemption authority advantageously implements a wall of separation between the entity administering exemption requests and the entity authorizing the exemption requests.

The authorization policy (138) is a set of rules governing whether to authorize performance of various system activities. For example, an authorization policy may specify that system administrators having a security clearance above a particular level are authorized to scan the ports of a server and manipulate sensitive system files while other system administrators having a security clearance below the particular level are not authorized to perform such system activity. In such an example, exemption requests originated by these system administrators having a security clearance below the particular level will not be authorized. The authorization policy (138) may grant privileges on the basis of an individual entity or an entity's membership in a group.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

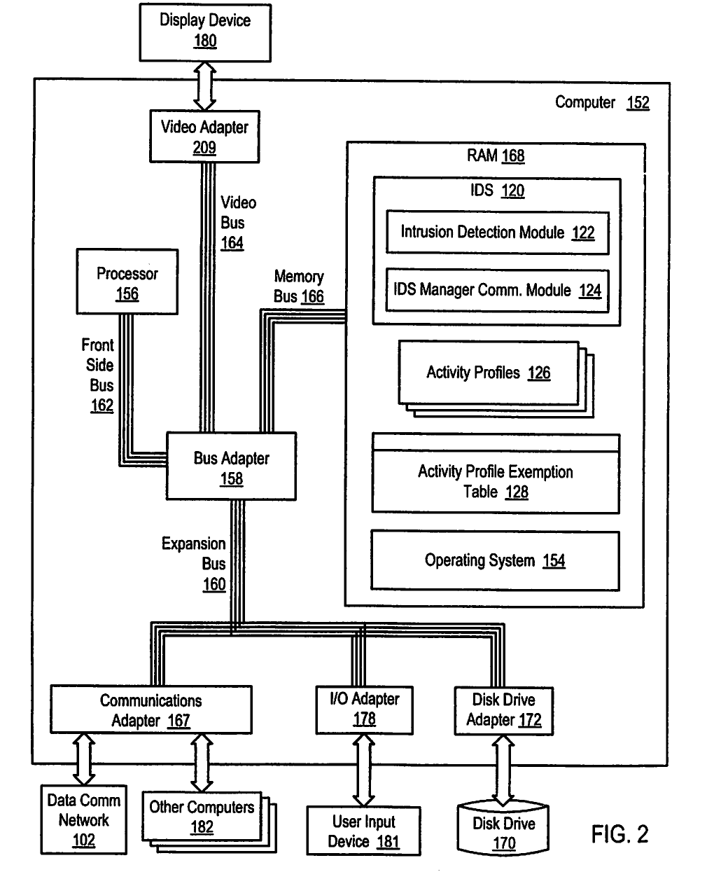

Preventing false positive detections in an intrusion detection system in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in preventing false positive detections in an intrusion detection system according to embodiments of the present invention. The computer (152) of FIG. 2 includes at least one computer processor (156) or ‘CPU’ as well as random access memory (168) (‘RAM’) which is connected through a high speed memory bus (166) and bus adapter (158) to processor (156) and to other components of the computer.

Stored in RAM (168) are an intrusion detection system (120), activity profiles (126), and an activity profile exemption table (128). The intrusion detection system (120) includes an intrusion detection module (122 and an intrusion detection manager communications module (124). Each activity profile (126) is data structure specifying a set of conditions that define a particular system activity for detection by an IDS. The activity profile exemption table (128) is a list of activity profiles that specify authorized system activity. The intrusion detection system (120), including the intrusion detection module (122) and the intrusion detection manager communications module (124), illustrated in FIG. 2 are software components, that is computer program instructions, that operate as described above with reference to FIG. 1.

Also stored in RAM (168) is an operating system (154). Operating systems useful in computers according to embodiments of the present invention include UNIX™, Linux™, Microsoft NT™, IBM's AIX™, IBM's i5/OS™, and others as will occur to those of skill in the art. The intrusion detection system (120), including the intrusion detection module (122) and the intrusion detection manager communications module (124), the activity profiles (126), and the activity profile exemption table (128) in the example of FIG. 2 are shown in RAM (168), but many components of such software typically are stored in non-volatile memory also, for example, on a disk drive (170).

The exemplary computer (152) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in computers useful according to embodiments of the present invention include the Intel Northbridge, the Intel Memory Controller Hub, the Intel Southbridge, and the Intel I/O Controller Hub. Examples of expansion buses useful in computers useful according to embodiments of the present invention may include Peripheral Component Interconnect (‘PCI’) buses and PCI Express (‘PCIe’) buses.

The exemplary computer (152) of FIG. 2 also includes disk drive adapter (172) coupled through expansion bus (160) and bus adapter (158) to processor (156) and other components of the exemplary computer (152). Disk drive adapter (172) connects non-volatile data storage to the exemplary computer (152) in the form of disk drive (170). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory (so-called ‘EEPROM’ or ‘Flash’ memory), RAM drives, and so on, as will occur to those of skill in the art.

The exemplary computer (152) of FIG. 2 includes one or more input/output (‘I/O’) adapters (178). I/O adapters in computers implement user-oriented input/output through, for example, software drivers and computer hardware for controlling output to display devices such as computer display screens, as well as user input from user input devices (181) such as keyboards and mice. The exemplary computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 2 includes a communications adapter (167) for data communications with other computers (182) and for data communications with a data communications network (102). Such data communications may be carried out through Ethernet™ connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for preventing false positive detections in an intrusion detection system according to embodiments of the present invention include modems for wired dial-up communications, IEEE 802.3 Ethernet adapters for wired data communications network communications, and IEEE 802.11b adapters for wireless data communications network communications.

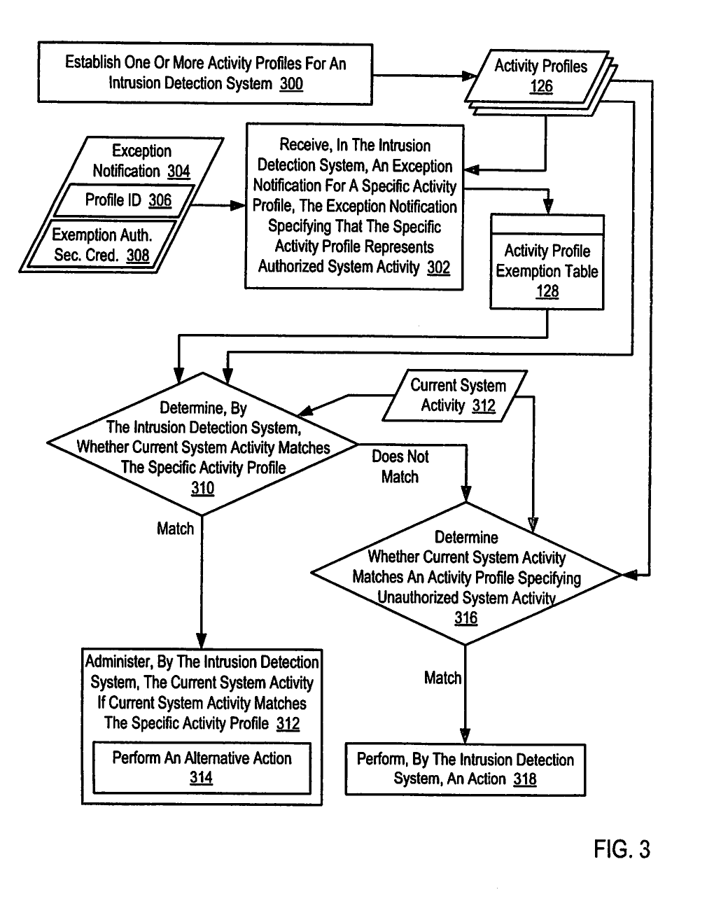

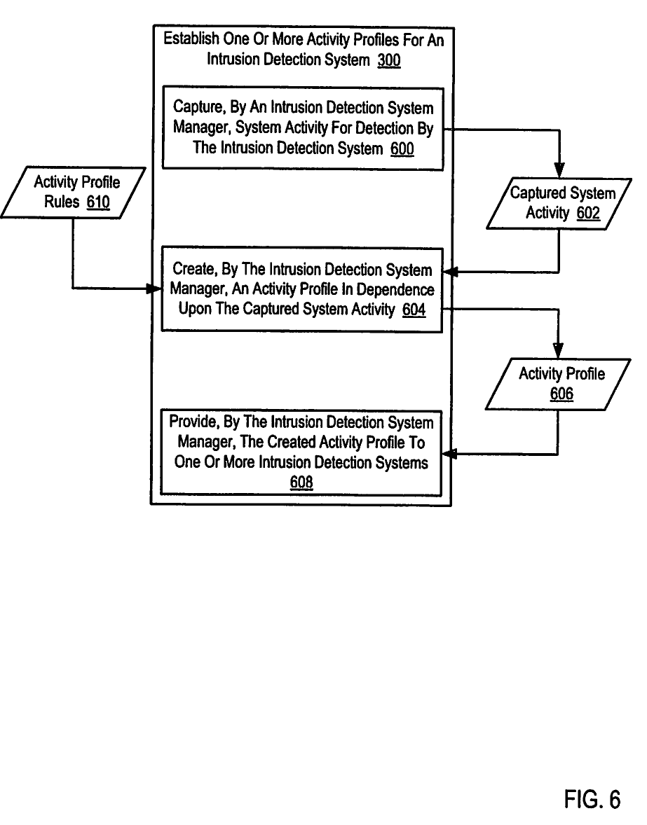

For further explanation, FIG. 3 sets forth a flow chart illustrating an exemplary method for preventing false positive detections in an intrusion detection system according to embodiments of the present invention. The method of FIG. 3 includes establishing (300) one or more activity profiles (126) for an intrusion detection system. In the example of FIG. 3, each activity profile (126) is a data structure specifying a set of conditions that define a particular system activity for detection by an IDS. In such a manner, each activity profile (126), therefore, specifies system activity for detection by the intrusion detection system. For example, an activity profile may specify conditions that are used to define when a user copies a particular file, when a node receives a particular pattern of data requests through a network, when a software component modifies system files, and so on. Establishing (300) one or more activity profiles (126) for an intrusion detection system according to the method of FIG. 3 may be carried out by capturing, by an intrusion detection system manager, system activity for detection by the intrusion detection system, creating, by the intrusion detection system manager, an activity profile in dependence upon the captured system activity, and providing, by the intrusion detection system manager, the created activity profile to one or more intrusion detection systems as discussed in more detail below with reference to FIG. 6.

The method of FIG. 3 also includes receiving (302), in the intrusion detection system, an exception notification (304) for a specific activity profile (126). The exception notification (304) of FIG. 3 specifies that a specific activity profile represents authorized system activity. In the example of FIG. 3, the exception notification (304) includes the activity profile identifier (306) that specifies the particular activity profile representing authorized system activity. The exception notification (304) of FIG. 3 also includes security credentials (308) of an exemption authority authorizing performance of the system activity specified in an activity profile identified by the profile identifier (306). The security credentials (308) may be implemented as a digital signature in a public key infrastructure, a security token, or any other security data as will occur to those of skill in the art for authenticating the identity of an IDS exemption authority. Examples of security token may include those security tokens described in the web services specification entitled ‘Web Services Security’ (‘WS-Security’) developed by IBM, Microsoft, and VeriSign or the web services specification entitled ‘Web Services Trust Language’ (‘WS-Trust’) developed by IBM, Microsoft, VeriSign, OpenNetworks, Layer 7, Computer Associates, BEA, Oblix, Reactivity, RSA Security, Ping Identity, and Actional.

The exemption notification (304) of FIG. 3 may also include other exemption notification data (not shown) describing the exemption of the authorized system activity from normal processing by an IDS or IPS to prevent or halt the system activity matching an activity profile. For example, other exception notification data may specify that the exception notification is valid only for a specific period of time, that the exception notification applies only to system activity occurring on a particular computer, and so on.

The intrusion detection system may receive an exception notification (304) for a specific activity profile (126) according to the method of FIG. 3 by receiving an indication that the exception notification (304) has arrived from an IDS manager and storing the activity profile identifier (306) included in the activity profile exemption table (128). Although the example of FIG. 3 includes an activity profile exemption table, readers will note that such an example is for explanation and not for limitation. The intrusion detection system may receive an exception notification (304) for a specific activity profile (126) according to the method of FIG. 3 by receiving, from an IDS manager, an activity profile that specifies in that the profile represent authorized system activity using a data field in the activity profile.

The method of FIG. 3 also includes determining (310), by the intrusion detection system, whether current system activity (312) matches the specific activity profile. The current system activity (312) of FIG. 3 represents the local system activity and network system activity of a computer device. The intrusion detection system may determine (310) whether current system activity (312) matches the specific activity profile according to the method of FIG. 3 by identifying whether the current system activity (312) satisfies all the conditions specified in one of the activity profiles (126), and identifying whether the activity profile for which all the conditions are satisfied by the current system activity is listed in the activity profile exemption table (128). If the activity profile for which all the conditions are satisfied by the current system activity is listed in the activity profile exemption table (128), then the current system activity (312) matches the specific activity profile that represent authorized system activity. The current system activity (312) does not match the specific activity profile, however, if the activity profile for which all the conditions are satisfied by the current system activity is not listed in the activity profile exemption table (128).

The method of FIG. 3 also includes determining (316), by the intrusion detection system, whether current system activity (312) matches an activity profile specifying unauthorized system activity if the current system activity (312) does not match the specific activity profile. The intrusion detection system may determining (316) whether current system activity (312) matches an activity profile specifying unauthorized system activity according to the method of FIG. 3 by identifying whether the current system activity (312) satisfies all the conditions specified in one of the activity profiles (126), and identifying whether the activity profile for which all the conditions are satisfied by the current system activity is listed in the activity profile exemption table (128). If the activity profile for which all the conditions are satisfied by the current system activity is not listed in the activity profile exemption table (128), then the current system activity (312) matches an activity profile specifying unauthorized system activity.

The method of FIG. 3 also includes performing (318), by the intrusion detection system, an action if the current system activity matches an activity profile specifying unauthorized system activity. The action performed by the intrusion detection system may include notifying an intrusion prevention system that unauthorized system activity is occurring. The intrusion prevention system may then operate to prevent or stop the unauthorized system activity from occurring. For example, if the intrusion detection system detects port scanning activity on a node, then the IDS may alert an IPS of such activity, which in turn may modify firewall rules to deny access to the node from the IP address associated with the port scanning activity.

The method of FIG. 3 also includes administering (312), by the intrusion detection system, the current system activity (312) if current system activity matches the specific activity profile. Administering (312), by the intrusion detection system, the current system activity (312) according to the method of FIG. 3 includes performing (314) an alternative action. The alternative action is an alternative action as compared to the action performed by the IDS when the current system activity matches an activity profile specifying unauthorized system activity. For example, when the current system activity matches an activity profile specifying a particular pattern of port scanning activity on a node, the IDS may deny access to the node from the IP address associated with the port scanning activity. An alternative action may include ignoring the current system activity or logging the current system activity as authorized system activity in non-volatile storage.

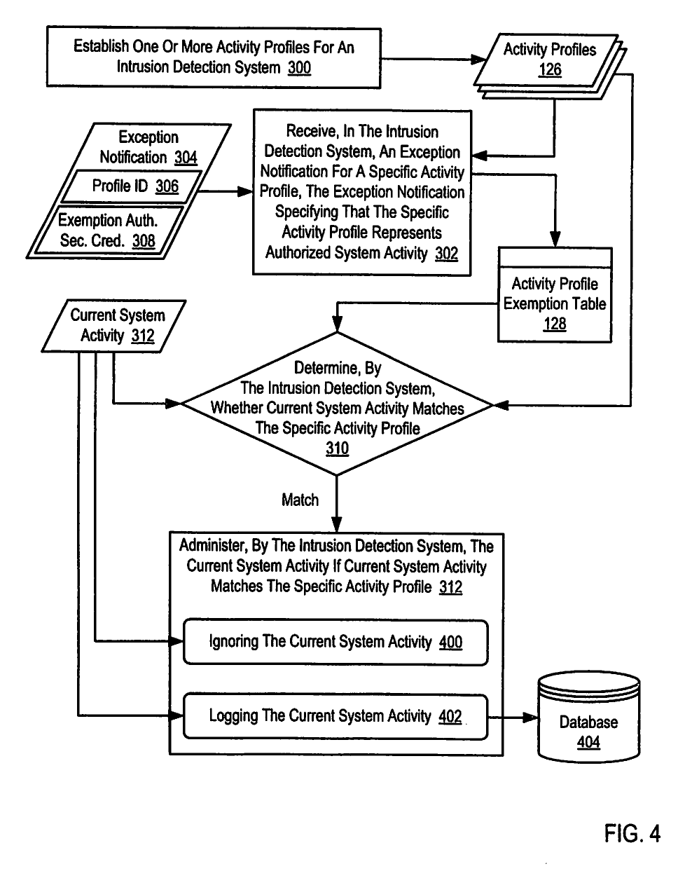

For further explanation, therefore, FIG. 4 sets forth a flow chart illustrating a further exemplary method for preventing false positive detections in an intrusion detection system according to embodiments of the present invention that includes ignoring (400) the current system activity (312) and logging (402) the current system activity (312). The method of FIG. 4 is similar to the method of FIG. 3 in that the method of FIG. 4 includes establishing (300) one or more activity profiles (126) for an intrusion detection system, each activity profile (126) specifying system activity for detection by the intrusion detection system, receiving (302), in the intrusion detection system, an exception notification (304) for a specific activity profile (126), the exception notification (304) specifying that the specific activity profile represents authorized system activity, determining (310), by the intrusion detection system, whether current system activity (312) matches the specific activity profile, and administering (312), by the intrusion detection system, the current system activity (312) if current system activity matches the specific activity profile. The example of FIG. 4 is also similar to the example of FIG. 3 in that the example of FIG. 4 includes an activity profile exemption table (128) and the exemption notification (304) includes an activity profile identifier (306) and exemption authority security credentials (308).

In the method of FIG. 4, administering (312), by the intrusion detection system, the current system activity (312) if current system activity matches the specific activity profile includes ignoring (400) the current system activity (312). Ignoring (400) the current system activity (312) advantageously prevents the intrusion detection system from attempting to stop the current system activity (312) when the current system activity (312) is authorized by an IDS exemption authority.

In the method of FIG. 4, administering (312), by the intrusion detection system, the current system activity (312) if current system activity matches the specific activity profile also includes logging (402) the current system activity (312). The intrusion detection system may log (402) the current system activity (312) according to the method of FIG. 4 by storing records of the transactions that constitute the current system activity (312) in a database (404). For example, the intrusion detection system may log (402) the current system activity (312) by recording the time at which the current system activity occurs, the computer on which the activity occurs, the operations that characterize the system activity, an identifier for the activity profile that specifies the system activity, the security credentials of the exemption authority authorizing the exemption notification for the activity profile specifying the system activity. In lieu of storing records of the transactions that constitute the current system activity (312) in a database (404), the instruction detection system may also log (402) the current system activity by storing data describing the current system activity (312) in more general data containers such as, for example, a file in a file system. Logging (402) the current system activity (312) according to the present invention advantageously provides a record of the exempted system activity for later audit by a system administrator or supervisor.

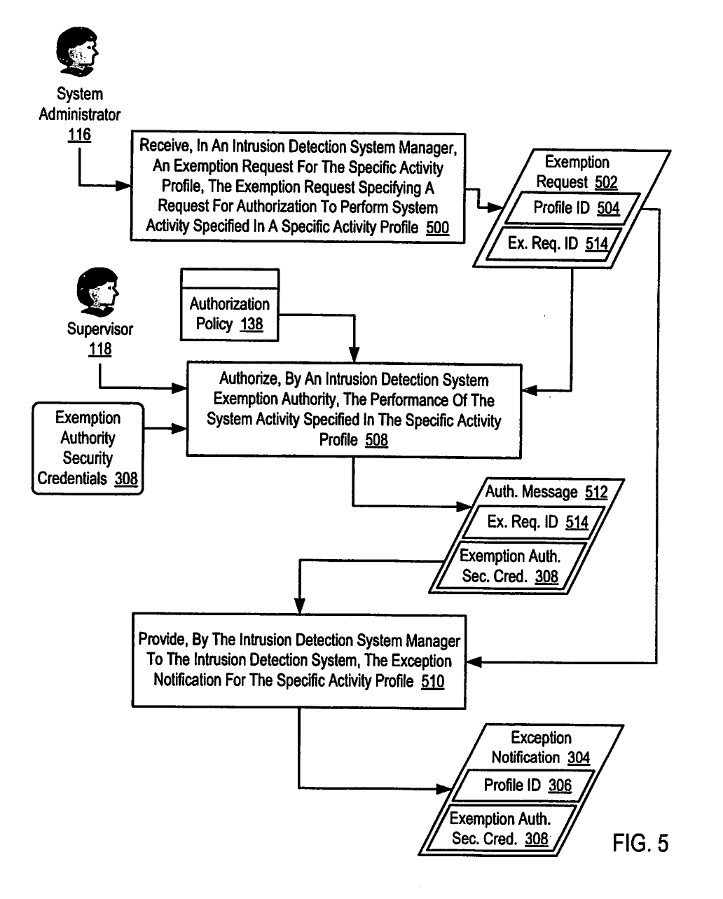

As mentioned above, an intrusion detection system may receive an exception notification for a specific activity profile from an intrusion detection system manager. For further explanation, therefore, FIG. 5 sets forth a flow chart illustrating a further exemplary method for preventing false positive detections in an intrusion detection system according to embodiments of the present invention that includes providing (510), by an intrusion detection system manager to an intrusion detection system, the exception notification (304) for a specific activity profile.

The method of FIG. 5 includes receiving (500), in an intrusion detection system manager, an exemption request (502) for a specific activity profile. The exemption request (502) is a data structure that specifies a request for authorization to perform system activity specified in the specific activity profile. The exemption request (502) of FIG. 5 includes an activity profile identifier (504) that specifies a specific activity profile for which an exemption is requested and an identifier (514) for the exemption request (502). The exemption request (502) of FIG. 5 may also include other exemption request data (not shown) used to specify a particular activity profile represents authorized system activity. For example, other exemption request data may specify that the exception is valid only for a specific period of time, the exception is only to system activity occurring on a particular computer, the system administrator who initiated the request, and so on. In the example of FIG. 5, the intrusion detection system receives (500) the exemption request (502) for the specific activity profile from a system administrator (116). The system administrator (116) may initiate the exemption request (502) because the administrator (116) desires to perform a particular system activity on a computer having installed upon it an intrusion detection system managed by the intrusion detection system manager.

The method of FIG. 5 also includes authorizing (508), by an intrusion detection system exemption authority, the performance of the system activity specified in the specific activity profile. The intrusion detection system exemption authority may authorize (508) the performance of the system activity according to the method of FIG. 5 by receiving the exemption request (502) from the IDS manager, providing authorization services for the IDS manager, and returning an authorization message (512) to the IDS manager. In the method of FIG. 5, the intrusion detection system exemption authority may provide authorization services for the IDS manager by submitting the exemption request (502) to a supervisor (118) for approval and granting authorization for the exemption request in dependence upon the supervisor's approval. Instead of submitting the exemption request (502) to the supervisor for manual review, the intrusion detection system exemption authority may also provide authorization services for the IDS manager by granting authorization for the exemption request (502) according to an authorization policy (138) established by the supervisor (118). In the example of FIG. 5, the authorization message (512) returned to the IDS manager includes an identifier (514) for the exemption request (502) and security credentials (308) for the IDS exemption authority. The IDS manager uses the security credentials to ensure that the authorization message (512) was generated by the IDS exemption authority.

The method of FIG. 5 also includes providing (510), by the intrusion detection system manager to the intrusion detection system, the exception notification (304) for the specific activity profile. The intrusion detection system manager may provide (510) the exception notification (304) for a specific activity profile to an intrusion detection system according to the method of FIG. 5 by generating the exemption notification (304) from the authorization message (512) received from the IDS exemption authority and the corresponding exemption request (502) identified by the exemption request identifier (514) in the authorization message (512) and transmitting the exemption notification (304) to the intrusion detection systems installed on computers for which the exemption notification (304) applies. The exemption notification (304) of FIG. 5 includes the identifier (306) for the activity profile for which the exemption notification (304) applies and the security credentials (308) of the exemption authority authorizing the exemption. The exemption notification (304) of FIG. 5 may also include other exemption data (not shown) describing the exemption of the authorized system activity from normal processing by an IDS or IPS to prevent or halt the system activity matching an activity profile. For example, other exception notification data may specify that the exception notification is valid only for a specific period of time, that the exception notification applies only to system activity occurring on a particular computer, and so on.

As mentioned above, preventing false positive detections in an intrusion detection system according to embodiments of the present invention includes establishing one or more activity profiles for an intrusion detection system. For further explanation, therefore, FIG. 6 sets forth a flow chart illustrating an exemplary method for establishing (300) one or more activity profiles (126) for an intrusion detection system according to embodiments of the present invention.

In the method of FIG. 6, establishing (300) one or more activity profiles (126) for an intrusion detection system includes capturing (600), by an intrusion detection system manager, system activity (602) for detection by the intrusion detection system. The intrusion detection system manager may capture (600) system activity (602) for detection by the intrusion detection system according to the method of FIG. 6 by recording a set of operations performed by a system administrator on a computer to simulate system activity such as, for example, local machine activity or network activity. In some embodiments, the set of operations constituting a particular system activity may already be recorded in file. In such embodiments, the intrusion detection system manager may capture (600) system activity (602) for detection by the intrusion detection system according to the method of FIG. 6 by retrieving the set of operations constituting a particular system activity from a file.

Establishing (300) one or more activity profiles (126) for an intrusion detection system according to the method of FIG. 6 also includes creating (604), by the intrusion detection system manager, an activity profile (606) in dependence upon the captured system activity (602). The intrusion detection system manager may create (604) an activity profile (606) in dependence upon the captured system activity (602) according to the method of FIG. 6 by generating a set of conditions to define the captured system activity (602) in an activity profile using activity profile rules (610). The activity profile rules (610) of FIG. 6 specify rules for transforming captured system activity stored in a particular data format to a data format used to specify the activity profile (606).

In the method of FIG. 6, establishing (300) one or more activity profiles (126) for an intrusion detection system includes providing (608), by the intrusion detection system manager, the created activity profile (606) to one or more intrusion detection systems. The intrusion detection system manager may provide (608) the created activity profile (606) to one or more intrusion detection systems according to the method of FIG. 6 by transmitting the created activity profile (606) to the intrusion detection systems through an IDS manager communications module of each intrusion detection system. As mentioned above, the IDS manager communications module may implement data communications between a particular IDS and the IDS manager using a CORBA framework, the Java Remote Method Invocation (‘RMI’) API, web services, or any other communication implementation as will occur to those of skill in the art.

In view of the explanations set forth above, readers will recognize that the benefits of preventing false positive detections in an intrusion detection system according to embodiments of the present invention include:
an ability of a system administrator to perform certain system activities without interference from an intrusion detection system,
decreases in system downtime that result from false positive detections by an intrusion detection system, and
a central exemption authority that authorizes the exemption of system activity from interference by an intrusion detection system.

Exemplary embodiments of the present invention are described largely in the context of a fully functional computer system for preventing false positive detections in an intrusion detection system. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of preventing false positive detections in an intrusion detection system, the method comprising:
establishing one or more activity profiles for an intrusion detection system, each activity profile specifying system activity for detection by the intrusion detection system;
receiving, in the intrusion detection system, an exception notification for a specific activity profile, the exception notification specifying that the specific activity profile represents authorized system activity;
determining, by the intrusion detection system, whether current system activity matches the specific activity profile; and
administering, by the intrusion detection system, the current system activity if current system activity matches the specific activity profile.

2. The method of claim 1 further comprising:
determining, by the intrusion detection system, whether current system activity matches an activity profile specifying unauthorized system activity; and
performing, by the intrusion detection system, an action if the current system activity matches an activity profile specifying unauthorized system activity,
wherein administering, by the intrusion detection system, the current system activity if current system activity matches the specific activity profile further comprises performing an alternative action.

3. The method of claim 1 wherein administering, by the intrusion detection system, the current system activity if current system activity matches the specific activity profile further comprises ignoring the current system activity.

4. The method of claim 1 wherein administering, by the intrusion detection system, the current system activity if current system activity matches the specific activity profile further comprises logging the current system activity.

5. The method of claim 1 further comprising:
receiving, in an intrusion detection system manager, an exemption request for the specific activity profile, the exemption request specifying a request for authorization to perform system activity specified in the specific activity profile;
authorizing, by an intrusion detection system exemption authority, the performance of the system activity specified in the specific activity profile; and
providing, by the intrusion detection system manager to the intrusion detection system, the exception notification for the specific activity profile.

6. The method of claim 1 wherein the intrusion detection system exemption authority provides authorization services for exemption requests received in a domain.

7. The method of claim 1 wherein establishing one or more activity profiles for an intrusion detection system further comprises:
capturing, by an intrusion detection system manager, system activity for detection by the intrusion detection system;
creating, by the intrusion detection system manager, an activity profile in dependence upon the captured system activity; and
providing, by the intrusion detection system manager, the created activity profile to one or more intrusion detection systems.

8. The method of claim 7 wherein the intrusion detection system manager manages the intrusion detection systems in a domain.

9. The method of claim 1 wherein the system activity is network activity.

10. The method of claim 1 wherein the exception notification comprises security credentials of an intrusion detection system exemption authority.

11. A system for preventing false positive detections in an intrusion detection system, the system comprising one or more computer processors, computer memory operatively coupled to the one or more computer processors, the computer memory having disposed within it computer program instructions capable of:
establishing one or more activity profiles for an intrusion detection system, each activity profile specifying system activity for detection by the intrusion detection system;
receiving, in the intrusion detection system, an exception notification for a specific activity profile, the exception notification specifying that the specific activity profile represents authorized system activity;
determining, by the intrusion detection system, whether current system activity matches the specific activity profile; and
administering, by the intrusion detection system, the current system activity if current system activity matches the specific activity profile.

12. The system of claim 11 further comprising computer program instructions capable of:
receiving, in an intrusion detection system manager, an exemption request for the specific activity profile, the exemption request specifying a request for authorization to perform system activity specified in the specific activity profile;
authorizing, by an intrusion detection system exemption authority, the performance of the system activity specified in the specific activity profile; and
providing, by the intrusion detection system manager to the intrusion detection system, the exception notification for the specific activity profile.

13. The system of claim 11 wherein establishing one or more activity profiles for an intrusion detection system further comprises:
capturing, by an intrusion detection system manager, system activity for detection by the intrusion detection system;
creating, by the intrusion detection system manager, an activity profile in dependence upon the captured system activity; and
providing, by the intrusion detection system manager, the created activity profile to one or more intrusion detection systems.

14. A computer program product for preventing false positive detections in an intrusion detection system, the computer program product disposed in a signal bearing medium, the computer program product comprising computer program instructions capable of:
establishing one or more activity profiles for an intrusion detection system, each activity profile specifying system activity for detection by the intrusion detection system;
receiving, in the intrusion detection system, an exception notification for a specific activity profile, the exception notification specifying that the specific activity profile represents authorized system activity;
determining, by the intrusion detection system, whether current system activity matches the specific activity profile; and
administering, by the intrusion detection system, the current system activity if current system activity matches the specific activity profile.

15. The computer program product of claim 14 wherein the signal bearing medium comprises a recordable medium.

16. The computer program product of claim 14 wherein the signal bearing medium comprises a transmission medium.

17. The computer program product of claim 14 further comprising computer program instructions capable of:
determining, by the intrusion detection system, whether current system activity matches an activity profile specifying unauthorized system activity; and
performing, by the intrusion detection system, an action if the current system activity matches an activity profile specifying unauthorized system activity,
wherein administering, by the intrusion detection system, the current system activity if current system activity matches the specific activity profile further comprises performing an alternative action.

18. The computer program product of claim 14 wherein administering, by the intrusion detection system, the current system activity if current system activity matches the specific activity profile further comprises ignoring the current system activity.

19. The computer program product of claim 14 further comprising computer program instructions capable of:
receiving, in an intrusion detection system manager, an exemption request for the specific activity profile, the exemption request specifying a request for authorization to perform system activity specified in the specific activity profile;
authorizing, by an intrusion detection system exemption authority, the performance of the system activity specified in the specific activity profile; and
providing, by the intrusion detection system manager to the intrusion detection system, the exception notification for the specific activity profile.

20. The computer program product of claim 14 wherein establishing one or more activity profiles for an intrusion detection system further comprises:
capturing, by an intrusion detection system manager, system activity for detection by the intrusion detection system;
creating, by the intrusion detection system manager, an activity profile in dependence upon the captured system activity; and
providing, by the intrusion detection system manager, the created activity profile to one or more intrusion detection systems.
